(19) United States
(12) Patent Application Publication
(10) Pub. No.: US 2024/0278426 A1
(43) Pub. Date: Aug. 22, 2024

(54) Method, System, and Computer Program Product for Applying Materials to a Substrate

(71) Applicant: Vitro Automatizacion, S.A. de C.V., Monterrey (MX)

(72) Inventors: Adrián Enrique Macouzet Díaz Leal, Tlalnepantla (MX); Gustav Abraham Chavez Guerrero, Monterrey (MX); Jose Manuel Contreras Lomeli, Monterrey (MX); Juan Salvador Farias Garza, San Pedro (MX); Raymundo Gonzalez Gonzalez, Monterrey (MX); Carlos Alberto Sandoval Mendo, Monterrey (MX)

(21) Appl. No.: 18/581,909

(22) Filed: Feb. 20, 2024

Related U.S. Application Data
(60) Provisional application No. 63/447,073, filed on Feb. 21, 2023.

(51) Int. Cl. B25J 9/16; B05B 13/04

(52) U.S. Cl. CPC B25J 9/1664; B05B 13/0431; B25J 9/1661

(57) ABSTRACT

A method, system, and computer program product for applying materials to a substrate. The method includes determining at least one optical indicium of a substrate based on data received from at least one optical detection system. The method also includes transmitting the at least one optical indicium to at least one edge computing device. The method further includes receiving at least one pattern from the at least one edge computing device. The method further includes controlling at least one robotic unit having at least one robot including at least one nozzle to apply at least one material to the substrate. Controlling the at least one robotic unit includes causing the at least one robotic unit to apply the at least one material to the substrate based on the at least one pattern.

### CROSS REFERENCE TO RELATED APPLICATION

This application claims priority to U.S. Provisional Patent Application No. 63/447,073, titled “Method, System, and Computer Program Product for Applying Materials to a Substrate”, filed Feb. 21, 2023, the disclosure of which is hereby incorporated by reference in its entirety.

### BACKGROUND

### 1. Technical Field

This disclosure relates generally to material assembly and, in non-limiting embodiments or aspects, to systems, methods, and computer program products for applying materials to a substrate.

### 2. Technical Considerations

Glass substrates are often treated or coated with various materials (e.g., coatings) to achieve certain properties, to allow the fastening of elements thereto, to meet certain safety standards, and/or to allow for the proper cleaning, activation, indication, or adhesion of the components to be integrated into or onto the substrate. The glass substrates are used for buildings, windows, solar cells, and the like, as well as in the automotive windows, such as windshields, medallions, rear windows, sidelites, roofs, sunroofs, and other accessories from the glass substrates. One example of a coating applied onto automotive windows is a black, ceramic frit, having a roughened surface that is applied along the marginal edge of the automotive windows to create a blackened area. A clear glass primer is typically applied before the application of the black ceramic frit to assist in the retention of the frit on the surface. These various layers can be applied by hand, by brushes manipulated by robots, or applied by spray nozzles; however, these processes often result in inadequate coating/application of the various layers onto the automotive windows, coating at the wrong location, and/or application of an excess of coatings, resulting in the waste of these expensive materials. The operation of the robot or spray nozzles is typically controlled by an operator followed by an operator-controlled inspection system, which can be labor intensive. Further, these coating systems usually only allow for the application of a specific coating profile onto a specifically shaped substrate.

There is a need in the art for a coating system and methodology for real-time control and real-time modification of the application of coatings onto substrates, such as glass substrates, for buildings and for the automotive industry.

### SUMMARY

According to some non-limiting embodiments or aspects, provided are methods, systems, and computer program products for applying materials to a substrate that overcome some or all of the deficiencies identified above.

According to some non-limiting embodiments or aspects, provided is a computer-implemented method for applying materials to a substrate. The method includes determining, with at least one processor, at least one optical indicium of a substrate based on data received from at least one optical detection system. The method also includes transmitting, with at least one processor, the at least one optical indicium to at least one edge computing device. The method further includes receiving, with at least one processor, at least one pattern from the at least one edge computing device. The method further includes controlling, with at least one processor, at least one robotic unit having at least one robot including at least one nozzle to apply at least one material to the substrate, wherein controlling the at least one robotic unit includes causing the at least one robotic unit to apply the at least one material to the substrate based on the at least one pattern.

In some non-limiting embodiments or aspects, causing the at least one robotic unit to apply the at least one material to the substrate based on the at least one pattern may include determining at least one application parameter using the at least one optical detection system while the at least one material is being applied to the substrate, wherein the at least one application parameter may include at least one of: an amount of the at least one material that has been applied to the substrate; a thickness of the at least one material that has been applied to the substrate; a width of the at least one material that has been applied to the substrate; a position of the at least one material that has been applied to the substrate; or any combination thereof. Causing the at least one robotic unit to apply the at least one material to the substrate based on the at least one pattern may also include continually modifying movement of the at least one robotic unit based on the at least one application parameter and the at least one pattern.

In some non-limiting embodiments or aspects, the at least one optical detection system may include a first optical detection system and a second optical detection system. The first optical detection system may have an optical view of a conveyor that conveys the substrate to the at least one robotic unit. The second optical detection system may have an optical view of the at least one robotic unit while the at least one material is being applied to the substrate. Determining the at least one optical indicium of the substrate based on the data received from the at least one optical detection system may include determining the at least one optical indicium of the substrate based on the data received from the first optical detection system. Determining the at least one application parameter using the at least one optical detection system may include determining the at least one application parameter using the second optical detection system.

In some non-limiting embodiments or aspects, the at least one robotic unit may include a first robotic unit and a second robotic unit, wherein the first robotic unit includes a first robot including a first nozzle for applying a first material of the at least one material to the substrate, the second robotic unit includes a second robot including a second nozzle for applying a second material of the at least one material to the substrate, and the second material is a different material from the first material. Controlling the at least one robotic unit to apply the at least one material to the substrate may include causing the first robotic unit to apply the first material to the substrate based on a first pattern of the at least one pattern, and causing the second robotic unit to apply the second material to the substrate based on a second pattern of the at least one pattern.

In some non-limiting embodiments or aspects, the substrate may be one of a plurality of different types of substrates. Transmitting the at least one optical indicium to the at least one edge computing device may include causing the at least one edge computing device to determine a type of the substrate based on the at least one optical indicium transmitted to the at least one edge computing device, and causing the at least one edge computing device to transmit the at least one pattern based on the type of the substrate.

In some non-limiting embodiments or aspects, the at least one optical indicium may include at least one of: a one-dimensional barcode, a two-dimensional barcode, printed symbols, a shape of the substrate, or any combination thereof.

In some non-limiting embodiments or aspects, the at least one optical detection system may include at least one laser system mounted on the at least one robotic unit. The at least one optical indicium may include the shape of the substrate. The method may further include determining, with at least one processor, the shape of the substrate in at least two dimensions based on data received from the at least one laser system.

In some non-limiting embodiments or aspects, causing the at least one robotic unit to apply the at least one material to the substrate based on the at least one pattern may include continually modifying movement of the at least one robotic unit based on the at least one pattern and based on ongoing data received from the at least one laser system.

In some non-limiting embodiments or aspects, the at least one laser system may function as a locator sensor and the ongoing data may include position data of the at least one material that has been applied to the substrate. Continually modifying the movement of the at least one robotic unit based on the at least one pattern and based on the ongoing data may include generating an application trajectory based on the ongoing data, comparing the application trajectory to a predetermined trajectory of the at least one pattern, and modifying the movement of the at least one robotic unit to adjust the application trajectory to be closer to the predetermined trajectory.

In some non-limiting embodiments or aspects, the substrate may be an automotive glass substrate and the at least one material may include a primer.

According to some non-limiting embodiments or aspects, provided is a system for applying materials to a substrate. The system includes at least one processor, at least one optical detection system, and at least one robotic unit having at least one robot including at least one nozzle configured to apply at least one material to a substrate. The at least one processor is programmed or configured to determine at least one optical indicium of the substrate based on data received from the at least one optical detection system. The at least one processor is also programmed or configured to transmit the at least one optical indicium to at least one edge computing device. The at least one processor is further programmed or configured to receive at least one pattern from the at least one edge computing device. The at least one processor is further programmed or configured to control the at least one robotic unit to apply at least one material to the substrate. Controlling the at least one robotic unit includes causing the at least one robotic unit to apply the at least one material to the substrate based on the at least one pattern.

In some non-limiting embodiments or aspects, when causing the at least one robotic unit to apply the at least one material to the substrate based on the at least one pattern, the at least one processor may be programmed or configured to determine at least one application parameter using the at least one optical detection system while the at least one material is being applied to the substrate, wherein the at least one application parameter includes at least one of: an amount of the at least one material that has been applied to the substrate; a thickness of the at least one material that has been applied to the substrate; a width of the at least one material that has been applied to the substrate; a position of the at least one material that has been applied to the substrate; or any combination thereof. When causing the at least one robotic unit to apply the at least one material to the substrate based on the at least one pattern, the at least one processor may be further programmed or configured to continually modify movement of the at least one robotic unit based on the at least one application parameter and the at least one pattern.

In some non-limiting embodiments or aspects, the at least one optical detection system may include a first optical detection system and a second optical detection system. The first optical detection system may have an optical view of a conveyor that conveys the substrate to the at least one robotic unit. The second optical detection system may have an optical view of the at least one robotic unit while the at least one material is being applied to the substrate. While determining the at least one optical indicium of the substrate based on the data received from the at least one optical detection system, the at least one processor may be programmed or configured to determine the at least one optical indicium of the substrate based on the data received from the first optical detection system. While determining the at least one application parameter using the at least one optical detection system, the at least one processor may be programmed or configured to determine the at least one application parameter using the second optical detection system.

In some non-limiting embodiments or aspects, the at least one robotic unit may include a first robotic unit and a second robotic unit, the first robotic unit may include a first robot including a first nozzle for applying a first material of the at least one material to the substrate, the second robotic unit may include a second robot including a second nozzle for applying a second material of the at least one material to the substrate, and the second material may be a different material from the first material. When controlling the at least one robotic unit to apply the at least one material to the substrate, the at least one processor may be programmed or configured to cause the first robotic unit to apply the first material to the substrate based on a first pattern of the at least one pattern, and cause the second robotic unit to apply the second material to the substrate based on a second pattern of the at least one pattern.

In some non-limiting embodiments or aspects, the substrate may be one of a plurality of different types of substrates. When transmitting the at least one optical indicium to the at least one edge computing device, the at least one processor may be programmed or configured to cause the at least one edge computing device to determine a type of the substrate based on the at least one optical indicium transmitted to the at least one edge computing device, and cause the at least one edge computing device to transmit the at least one pattern based on the type of the substrate.

In some non-limiting embodiments or aspects, the at least one optical indicium may include at least one of: a one-dimensional barcode, a two-dimensional barcode, printed symbols, a shape of the substrate, or any combination thereof.

In some non-limiting embodiments or aspects, the at least one optical detection system may include at least one laser system mounted on the at least one robotic unit. The at least one optical indicium may include the shape of the substrate, and the at least one processor may be further programmed or configured to determine the shape of the substrate in at least two dimensions based on data received from the at least one laser system.

In some non-limiting embodiments or aspects, when causing the at least one robotic unit to apply the at least one material to the substrate based on the at least one pattern, the at least one processor may be programmed or configured to continually modify movement of the at least one robotic unit based on the at least one pattern and based on ongoing data received from the at least one laser system.

In some non-limiting embodiments or aspects, the at least one laser system may function as a locator sensor and the ongoing data may include position data of the at least one material that has been applied to the substrate. When continually modifying the movement of the at least one robotic unit based on the at least one pattern and based on the ongoing data, the at least one processor may be programmed or configured to generate an application trajectory based on the ongoing data, compare the application trajectory to a predetermined trajectory of the at least one pattern, and modify the movement of the at least one robotic unit to adjust the application trajectory to be closer to the predetermined trajectory.

In some non-limiting embodiments or aspects, the substrate may be an automotive glass substrate and the at least one material may include a primer.

According to some non-limiting embodiments or aspects, provided is a computer program product for applying materials to a substrate. The computer program product includes at least one non-transitory computer-readable medium including one or more instructions that, when executed by at least one processor, cause the at least one processor to determine at least one optical indicium of a substrate based on data received from at least one optical detection system. The one or more instructions also cause the at least one processor to transmit the at least one optical indicium to at least one edge computing device. The one or more instructions further cause the at least one processor to receive at least one pattern from the at least one edge computing device. The one or more instructions further cause the at least one processor to control at least one robotic unit having at least one robot including at least one nozzle to apply at least one material to the substrate, wherein the one or more instructions that cause the at least one processor to control the at least one robotic unit, cause the at least one processor to cause the at least one robotic unit to apply the at least one material to the substrate based on the at least one pattern.

In some non-limiting embodiments or aspects, the one or more instructions that cause the at least one processor to cause the at least one robotic unit to apply the at least one material to the substrate based on the at least one pattern, may cause the at least one processor to determine at least one application parameter using the at least one optical detection system while the at least one material is being applied to the substrate, wherein the at least one application parameter includes at least one of: an amount of the at least one material that has been applied to the substrate; a thickness of the at least one material that has been applied to the substrate; a width of the at least one material that has been applied to the substrate; a position of the at least one material that has been applied to the substrate; or any combination thereof. The one or more instructions that cause the at least one processor to cause the at least one robotic unit to apply the at least one material to the substrate based on the at least one pattern, may cause the at least one processor to continually modify movement of the at least one robotic unit based on the at least one application parameter and the at least one pattern.

In some non-limiting embodiments or aspects, the at least one optical detection system may include a first optical detection system and a second optical detection system. The first optical detection system may have an optical view of a conveyor that conveys the substrate to the at least one robotic unit. The second optical detection system may have an optical view of the at least one robotic unit while the at least one material is being applied to the substrate. The one or more instructions that cause the at least one processor to determine the at least one optical indicium of the substrate based on the data received from the at least one optical detection system may cause the at least one processor to determine the at least one optical indicium of the substrate based on the data received from the first optical detection system. The one or more instructions that cause the at least one processor to determine the at least one application parameter using the at least one optical detection system may cause the at least one processor to determine the at least one application parameter using the second optical detection system.

In some non-limiting embodiments or aspects, the at least one robotic unit may include a first robotic unit and a second robotic unit, the first robotic unit may include a first robot including a first nozzle for applying a first material of the at least one material to the substrate, the second robotic unit may include a second robot including a second nozzle for applying a second material of the at least one material to the substrate, and the second material may be a different material from the first material. The one or more instructions that cause the at least one processor to control the at least one robotic unit to apply the at least one material to the substrate, may cause the at least one processor to cause the first robotic unit to apply the first material to the substrate based on a first pattern of the at least one pattern, and cause the second robotic unit to apply the second material to the substrate based on a second pattern of the at least one pattern.

In some non-limiting embodiments or aspects, the substrate may be one of a plurality of different types of substrates. The one or more instructions that cause the at least one processor to transmit the at least one optical indicium to the at least one edge computing device may cause the at least one processor to cause the at least one edge computing device to determine a type of the substrate based on the at least one optical indicium transmitted to the at least one edge computing device, and cause the at least one edge computing device to transmit the at least one pattern based on the type of the substrate.

In some non-limiting embodiments or aspects, the at least one optical indicium may include at least one of: a one-dimensional barcode, a two-dimensional barcode, printed symbols, a shape of the substrate, or any combination thereof.

In some non-limiting embodiments or aspects, the at least one optical detection system may include at least one laser system mounted on the at least one robotic unit. The at least one optical indicium may include the shape of the substrate, and the one or more instructions may further cause the at least one processor to determine the shape of the substrate in at least two dimensions based on data received from the at least one laser system.

In some non-limiting embodiments or aspects, the one or more instructions that cause the at least one processor to cause the at least one robotic unit to apply the at least one material to the substrate based on the at least one pattern may cause the at least one processor to continually modify movement of the at least one robotic unit based on the at least one pattern and based on ongoing data received from the at least one laser system.

In some non-limiting embodiments or aspects, the at least one laser system may function as a locator sensor and the ongoing data may include position data of the at least one material that has been applied to the substrate. The one or more instructions that cause the at least one processor to continually modify the movement of the at least one robotic unit based on the at least one pattern and based on the ongoing data may cause the at least one processor to generate an application trajectory based on the ongoing data, compare the application trajectory to a predetermined trajectory of the at least one pattern, and modify the movement of the at least one robotic unit to adjust the application trajectory to be closer to the predetermined trajectory.

In some non-limiting embodiments or aspects, the substrate may be an automotive glass substrate and the at least one material may include a primer.

These and other features and characteristics of the present disclosure, as well as the methods of operation and functions of the related elements of structures and the combination of parts and economics of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the present disclosure. As used in the specification and the claims, the singular form of “a,” “an,” and “the” include plural referents unless the context clearly dictates otherwise.

### BRIEF DESCRIPTION OF THE DRAWINGS

The above-mentioned and other features and advantages of this disclosure, and the manner of attaining them, will become more apparent and the disclosure itself will be better understood by reference to the following descriptions of embodiments of the disclosure taken in conjunction with the accompanying drawings. Unless indicated to the contrary, the drawing figures are not to scale.

FIG. 1A is a perspective back view of a robotic coating applicator in accordance with an embodiment of the present disclosure;

FIG. 1B is a perspective front view of the robotic coating applicator of FIG. 1A in accordance with an embodiment of the present disclosure;

FIG. 2A is a back view of the robotic coating applicator of FIGS. 1A and 1B in accordance with an embodiment of the present disclosure;

FIG. 2B is a side view of the robotic coating applicator of FIGS. 1A and 1B in accordance with an embodiment of the present disclosure;

FIG. 2C is a front view of the robotic coating applicator of FIGS. 1A and 1B in accordance with an embodiment of the present disclosure;

FIG. 3A is a top view of the robotic coating applicator of FIGS. 1A and 1B in accordance with an embodiment of the present disclosure;

FIG. 3B is a bottom view of the robotic coating applicator of FIGS. 1A and 1B in accordance with an embodiment of the present disclosure;

FIG. 4 is a front perspective view of a coating system using a series of the robotic coating applicator of FIGS. 1A and 1B in accordance with an embodiment of the present disclosure;

FIG. 5A is a front view of the coating system of FIG. 4 in accordance with an embodiment of the present disclosure;

FIG. 5B is a top view of the coating system of FIG. 4 in accordance with an embodiment of the present disclosure;

FIG. 6 is an overall coating system for real-time control and real-time modification of the application of various coating layers to a substrate in accordance with an embodiment of the present disclosure;

FIGS. 7A-7D show various shaped substrates that can be coated with the coating system of FIG. 4 and/or FIG. 6 in accordance with an embodiment of the present disclosure;

FIG. 8 is a diagram of a non-limiting embodiment or aspect of an environment in which systems, devices, products, apparatus, and/or methods, described herein, may be implemented according to the principles of the present disclosure;

FIG. 9 is a diagram of one or more components, devices, and/or systems, according to some non-limiting embodiments or aspects of the present disclosure;

FIG. 10 is a flowchart of a method for applying material to a substrate, according to some non-limiting embodiments or aspects of the present disclosure; and

FIG. 11 is a flowchart of a system in an accordance with an embodiment of the present disclosure.

The above-mentioned and other features and advantages of this disclosure, and the manner of attaining them, will become more apparent and the disclosure itself will be better understood by reference to the following descriptions of embodiments of the disclosure taken in conjunction with the accompanying drawings.

### DETAILED DESCRIPTION

Spatial or directional terms used herein, such as “left”, “right”, “upper”, “lower”, and the like, relate to the disclosure as it is shown in the drawing figures. It is to be understood that the disclosure can assume various alternative orientations and, accordingly, such terms are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. The phase “based on” may also mean “in response to” where appropriate.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, and/or the like.

As used herein, spatial or directional terms, such as “left”, “right”, “inner”, “outer”, “above”, “below”, and the like, relate to the disclosure as it is shown in the drawing figures. However, it is to be understood that the disclosure can assume various alternative orientations and, accordingly, such terms are not to be considered as limiting. Further, as used herein, all numbers expressing dimensions, physical characteristics, processing parameters, quantities of ingredients, reaction conditions, and the like, used in the specification and claims are to be understood as being modified in all instances by the term “about”. Accordingly, unless indicated to the contrary, the numerical values set forth in the following specification and claims may vary depending upon the desired properties sought to be obtained by the present disclosure. At the very least, and not as an attempt to limit the application of the doctrine of equivalents to the scope of the claims, each numerical value should at least be construed in light of the number of reported significant digits and by applying ordinary rounding techniques. Moreover, all ranges disclosed herein are to be understood to encompass the beginning and ending range values and any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 1 to 3.3, 4.7 to 7.5, 5.5 to 10, and the like. Additionally, all documents, such as but not limited to, issued patents and patent applications, referred to herein are to be considered to be “incorporated by reference” in their entirety.

All numbers used in the specification and claims are to be understood as being modified in all instances by the term “about”. All ranges disclosed herein are to be understood to encompass the beginning and ending range values and any and all subranges subsumed therein. The ranges set forth herein represent the average values over the specified range. Any reference to amounts, unless otherwise specified, is “by weight percent”.

All documents referred to herein are to be considered to be “incorporated by reference” in their entirety.

The discussion of the disclosure herein may describe certain features as being “particularly” or “preferably” within certain limitations (e.g., “preferably”, “more preferably”, or “even more preferably”, within certain limitations). It is to be understood that the disclosure is not limited to these particular or preferred limitations but encompasses the entire scope of the disclosure.

As used herein, the transitional term “comprising” (and other comparable terms, e.g., “containing” and “including”) is “open-ended” and open to the inclusion of unspecified matter. Although described in terms of “comprising”, the terms “consisting essentially of” and “consisting of” are also within the scope of this disclosure.

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “server” may refer to or include one or more computing devices that are operated by or facilitate communication and processing for multiple parties in a network environment, such as the internet, although it will be appreciated that communication may be facilitated over one or more public or private network environments and that various other arrangements are possible. Further, one or more computing devices (e.g., servers, mobile devices, etc.) directly or indirectly communicating in the network environment may constitute a “system.” Reference to “a server” or “a processor,” as used herein, may refer to a previously recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

The disclosure comprises, consists of, or consists essentially of, the following aspects of the disclosure, in any combination. Various aspects of the disclosure are illustrated in separate drawing figures. However, it is to be understood that this is simply for case of illustration and discussion. In the practice of the disclosure, one or more aspects of the disclosure shown in one drawing figure can be combined with one or more aspects of the disclosure shown in one or more of the other drawing figures.

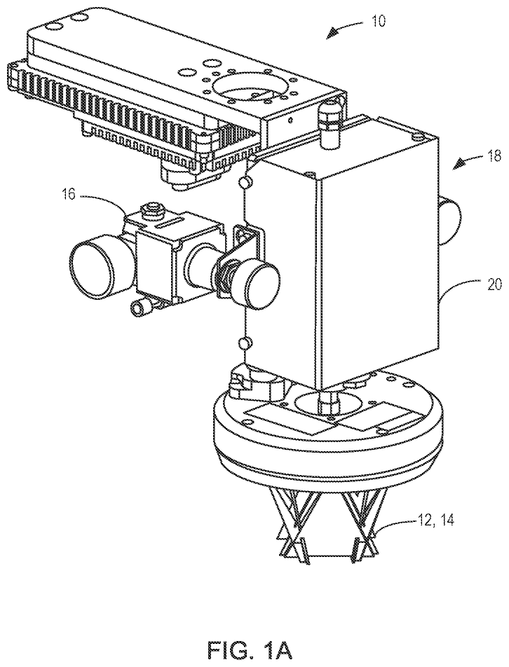

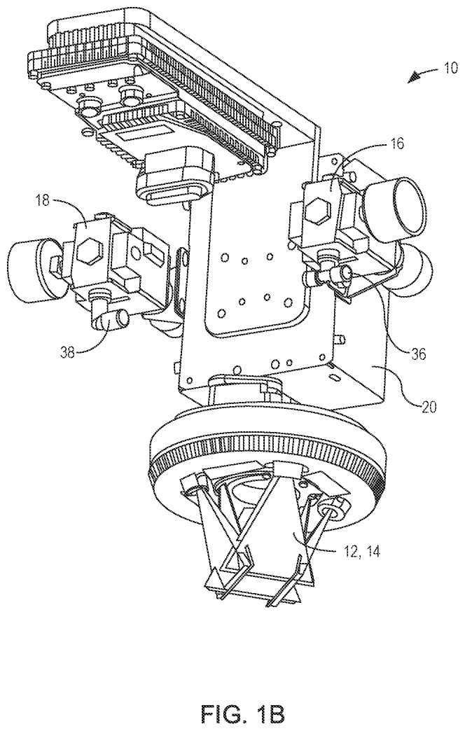

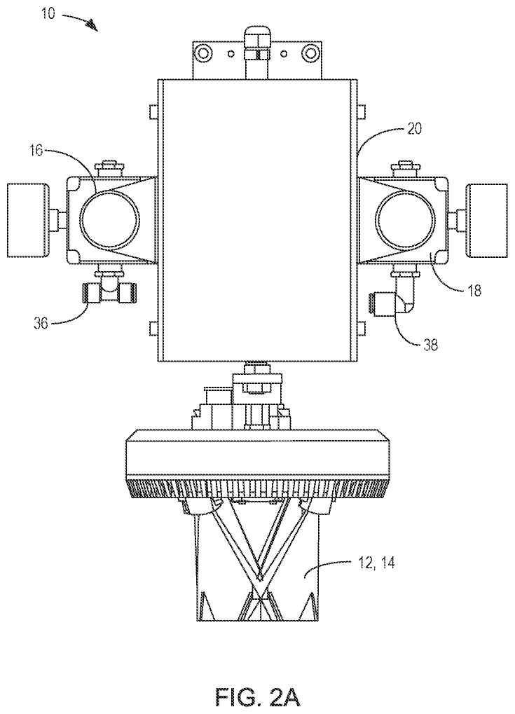

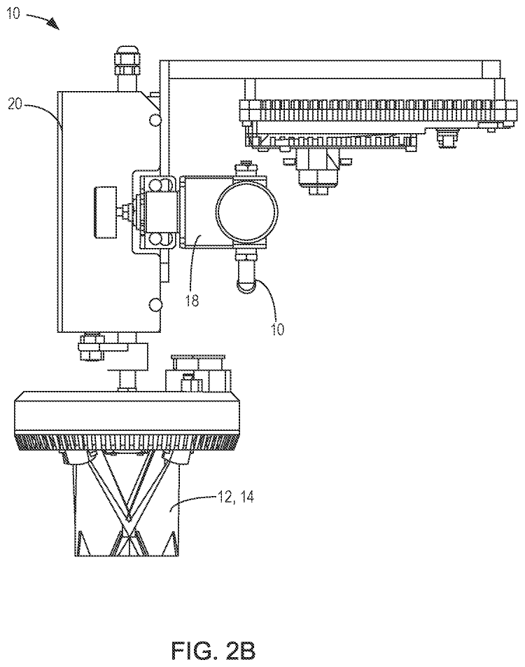

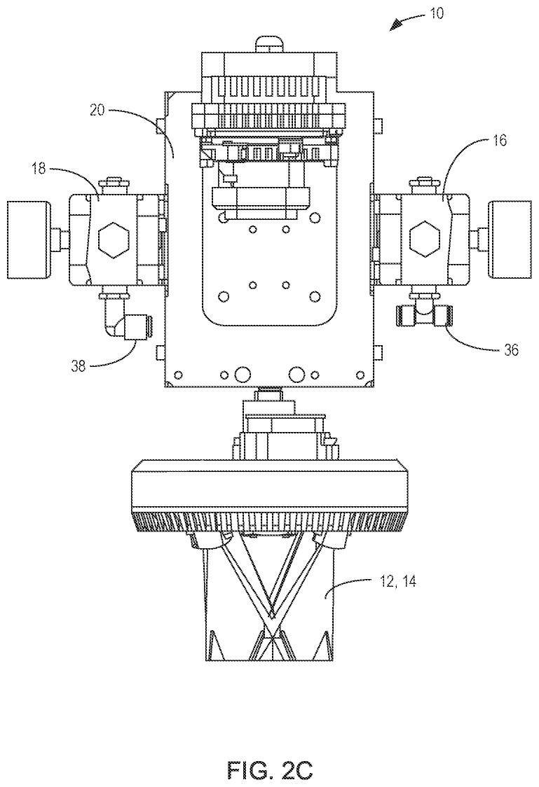

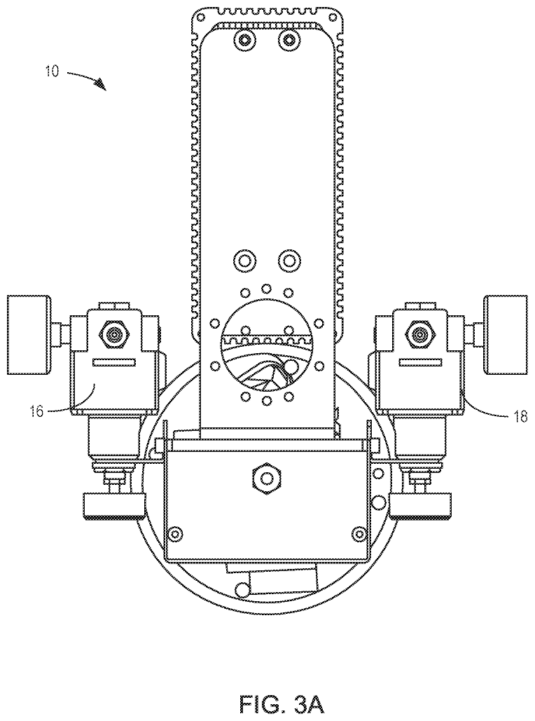

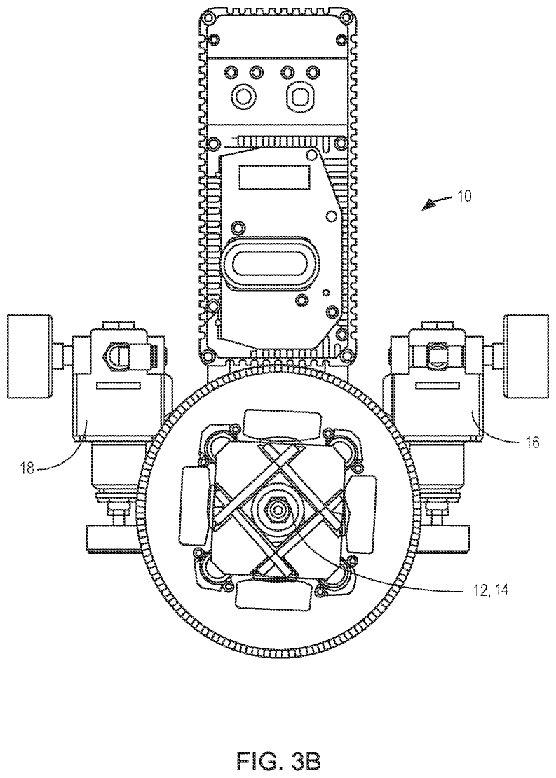

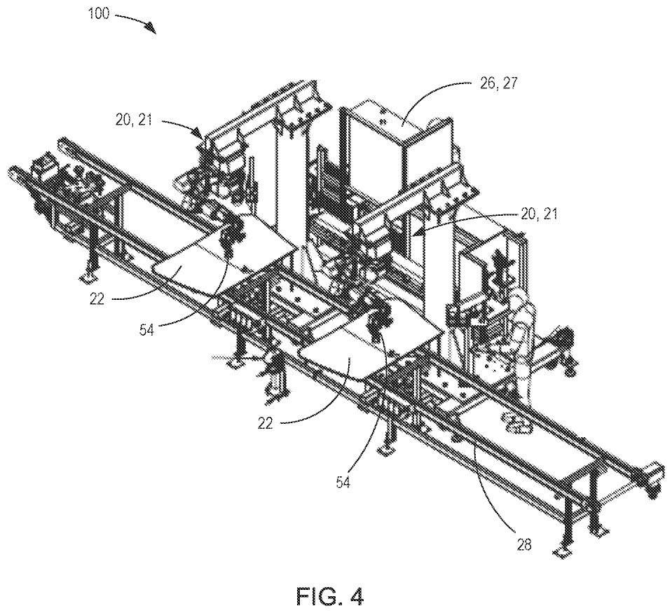

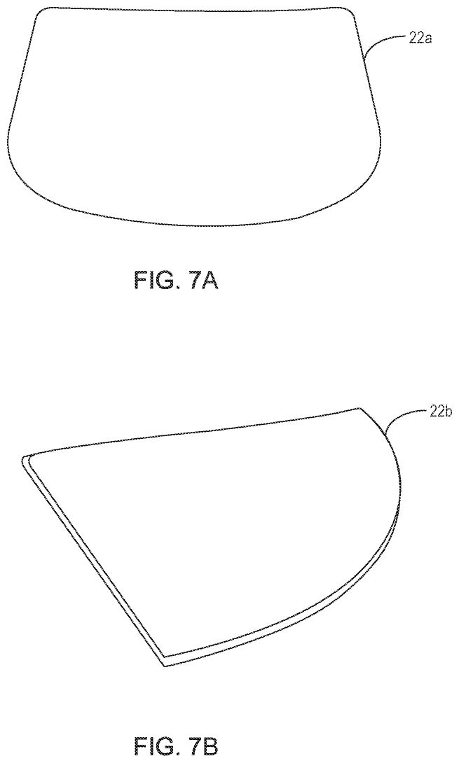

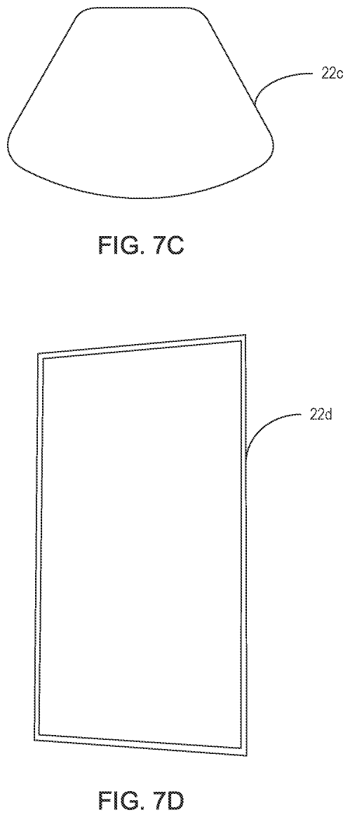

Reference is now made to FIGS. 1A, 1B, 2A-2C, 3A, and 3B, which show various views of a robotic coating applicator, generally indicated as 10, in accordance with an embodiment of the present disclosure. Referring now to FIGS. 4, 5A, 5B, and 6, the robotic coating applicator 10 can comprise a first applicator 10a that is mounted on a first robotic unit 24a. The first applicator 10a includes at least a first nozzle 12 for applying at least a first coating. A second applicator 10b can be provided on the first robotic unit 24a, wherein the second applicator 10b includes a second nozzle 14 for applying at least a second coating. The first and second coatings can be supplied from a pumping system 20 and dispensing system 21 onto the surface of the substrate 22. The substrate 22 can include any known substrate, including glass, plastic, or multi-layer substrates used for buildings, windows, solar cells, and the like, as well as glass substrates used in the automotive windows, such as windshields, medallions, rear windows, sidelites, roofs, sunroofs and other accessories from the glass substrates. It can be appreciated that the substrate 22 can be curved or flat and can have various shapes 22a-22d, examples of which are shown in FIGS. 7A-7D.

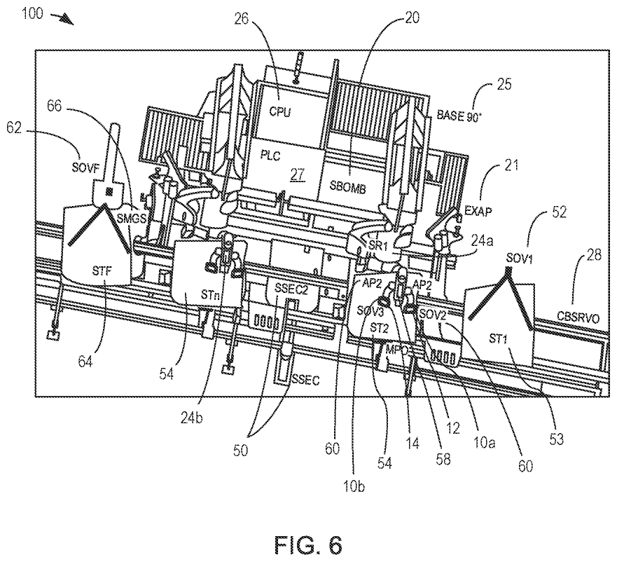

The first robotic unit 24a is movable with respect to the surface of the substrate 22. According to one embodiment, the first robotic unit 24a can include at least two 90° angled structures (BASE 90°) 25, as shown in FIG. 6, that rigidly support the first robotic unit 24a.

The applied materials (e.g., coatings) can comprise any well-known coating materials such as one or more various primer layers, paints, adhesive agents, tinting/coloring agents, chemical solvents, nanoparticles, and the like.

Referring back to FIGS. 1A, 1B, 2A-2C, 3A, and 3B, at least a first laser system 16 and at least a second laser system 18 is mounted on each of the first applicator 10a and second applicator 10b for observing a shape of the substrate 22 and for monitoring the application of at least the first coating and/or the second coating onto the surface of the substrate 22. A control unit 26, along with a programmable logic controller 27, shown in FIGS. 4, 5A, and 6, cooperate with the first laser system 16 and the second laser system 18 to effect real-time modification of the movement of the first robotic unit 24a during the application of the coatings onto the substrate 22 based on the observed shape of the substrate 22 and for controlling the first nozzle 12 and the second nozzle 14 to control the application of the first and second coatings onto the substrate 22.

The pumping and dispensing systems 20, 21 can be configured for supplying different coating materials to the first nozzle 12 and the second nozzle 14 so that different coatings can be applied onto the surface of the substrate 22 using a single robotic unit 24a. The first and second laser systems 16, 18 can be configured for observing an amount and/or thickness of coating applied to the surface of the substrate 22. The control unit 26 is configured for real-time modification of the amount of coating applied to the surface of the substrate 22.

According to one embodiment, at least the first laser system 16 can function as a locator sensor for observing the substrate 22 and for generating a search trajectory and comparing the search trajectory against a previously learned master pattern. At least the first laser system 16 can include a first laser sensor 36 configured for generating a real-time three-dimensional image of a coating route for at least the first robotic unit 24a for application of the first coating by the first applicator 10a. This first laser system 16, along with the second laser system 18, having a second laser sensor 38, can function as an inspection system that measures the quantity, position, width, and thickness of the coating applied to the substrate 22. A similar two-part laser system can be associated with the second robotic applicator 10b. The first and second laser systems 16, 18 associated with the first and second applicators 10a, 10b function to control the movement of the first robotic unit 24a.

It can be appreciated that the control unit 26 can also be configured for monitoring the pumping and dispensing systems 20, 21 to determine when at least the first coating and the second coating require replenishment. The control unit 26 can separately control the pumping and dispensing systems 20, 21, wherein it can separately turn on and separately turn off the application of a first coating or the second coating.

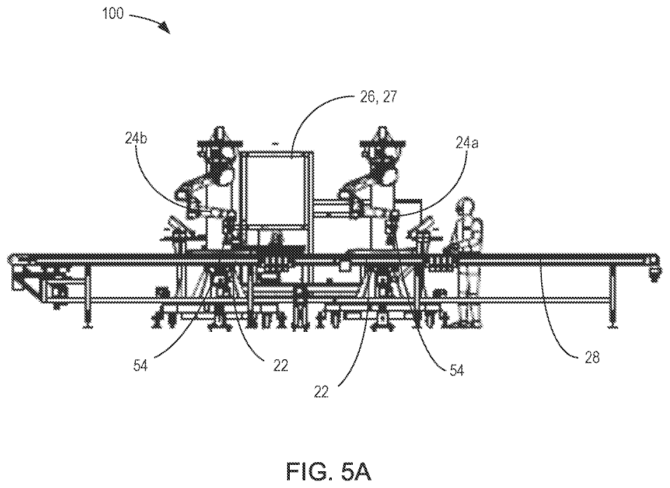

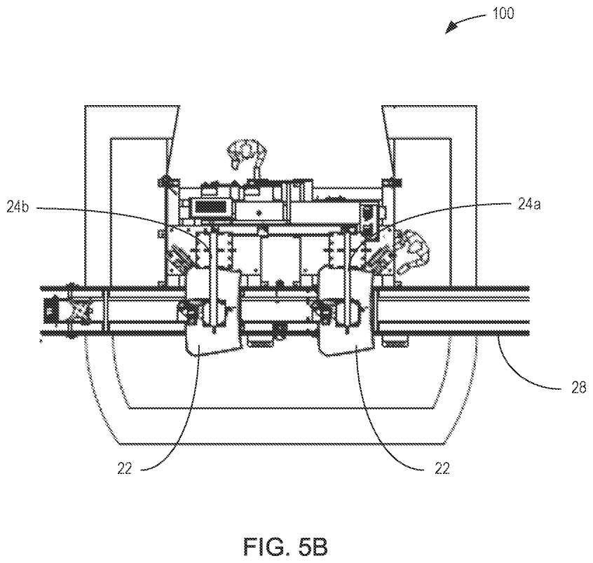

The system can further include a conveyor 28 for transporting the substrate 22 or a series of substrates “22n”, where “n” represents any number of items. It can be appreciated that at least a second robotic unit 24b, shown in FIGS. 5A and 6, can be provided, wherein the second robotic unit 24b also includes first and second applicators 10a, 10b, as described above. It can further be appreciated that a series of robotic units “24n”, including a series of applicators “10n”, can be provided along the conveyor 28 to apply a series of coatings onto the substrate 22. As discussed above in relation to the first robotic unit 24a, the second robotic unit 24b or a series of robotic units are movable with respect to the substrate 22. The conveyor 28 can include a series of security scanners/sensors 50, shown in FIG. 6, located adjacent to the conveyor 28, wherein a detection of an abnormality with the substrate 22 or a detection of a foreign object within a predetermined safe zone by one or more of the security scanners 50 sends a signal to the control unit 26 to control the movement of the conveyor 28 and/or at least the first robotic applicator 10a.

The control unit 26 can be configured for real-time modification of a speed at which the coating is dispensed from the first nozzle 12 and/or second nozzle 14 of the robotic applicators 10a, 10b.

Reference is now made to FIG. 6 which illustrates an overall system 100 for the application of chemical solvents on substrates, such as glass substrates for use in both flat and automotive applications. For example, system 100 depicts control architecture for a flex priming machine. The system includes a conveyor 28, which can be in the form of a servo-motorized chain whose purpose is to transport the glass substrate to various processing stations (ST1,2,n,F) 53, 54, 64. An initial optical vision system (SOV1) 52 is provided at the initial processing station 53 (ST1) to identify the model, type, size, application route, number of chemical solvents required, application order, drying time, activation time, inspection of correct application, and inspection of a compliant or non-compliant product. The initial optical vision system 52 is connected to a central processing unit (CPU) 26 and data cloud for the recognition of substrate shape, position, pattern, application variables such as contours, curvatures, number of chemical solvents required, dwell times, activation times, and release times.

The system 100 includes one or more security sensors (SSEC) (SSEC2) 50 for industrial safety, which can be programmed to detect safe zone, preventive zone, and total stop zone due to the invasion of any object or person within the assigned work area.

According to one embodiment, the system 100 can be used for applying chemical solvents to a plurality of substrates 22 in application stages. The servo motorized conveyor 28 places the flat or automotive-type glass substrate at processing station (ST2) 54, where a servo-pneumatic clamping system or positioning mechanism (MPO) 56 will provide the support and force required to keep the glass substrate 22 in position to enable the robotic coating applicator 10 to scan, apply the coating, and inspect each application of the coating to ensure that such coating application is in compliance with the application pattern, quantity, and time of application.

As discussed above, the system 100 comprises chemical solvent pumping systems (SBOMB) 20 controlled by means of a programmable logic system 26, 27 which controls the pressure and flow of the chemical, these values change depending on the algorithm of the data obtained from the central processing unit 26 and the data cloud. The overall system 100 includes coating applicators (AP1, 2 . . . n) 10a, 10b . . . 10n, as discussed above, which allow for the proper application of a series of coatings on the substrates 22. These applicators 10a, 10b can be replaced by the robotic system (SR1) 58, by the sequence of use, wear, or change of product.

With continuing reference to FIG. 6, the system 100 includes applicator dispensing elements (EXAP) 21 in types and shapes required to meet the programmed needs depending directly on the type of glass substrate to be processed, flat or automotive application. Overall optical-vision systems (SOV2, SOV3) 60 including lasers 16, 18, as discussed above, are mounted on the first and second applicators 10a, 10b to check the position of the substrate to determine the initial process area, previously checking by means of data exchange from the central processing unit 26, programmable logic control 27, and data cloud. The system 100 is designed to initiate the application of the coatings (chemical, solvents, and the like) by means of the defined and required applicators (AP1, AP2) 10a, 10b in different areas and profile of the substrate 22, wherein the processor optical-vision system (SOV2, SOV3) 60 mounted together with the applicators 10a, 10b will check in real-time if the pattern applied is effectively applied in accordance with the data load previously obtained in the database of patterns and chemicals extracted from the central processing unit 26, programmable logic control 27, and data cloud. According to one embodiment, the processor optical-vision system (SOV2, SOV3) 60 will send the data obtained in real-time to be compared in the central processing unit 26, which will issue follow-up orders on the application pattern in the event that any area is left without the correct application of the chemical. The system 100 will receive instructions from the central processing unit 26 to create a programmable logic system application routine in the area or profile where the incorrect application occurred. This data will be sent back to the central processing unit 26 and the data cloud to obtain metrics in the process control. During its validation stage, the optical-vision system 60 will check by means of the comparison of patterns its validity or invalidity in the final optical vision system (SOVF) 62 and a final processing station (STF) 54, and registering in the programmable logic control 27 and at the same time in the central processing unit 26 and data cloud. This data will be obtained by a marking system (SMGS) 66 that will record the required traceability data of at least the applied sequence so that it can be easily consulted in the system data and, thus, provide a correct traceability process of the application of chemical solvents on the processed substrate 22.

Now referring to FIGS. 5A and 5B and with continuing reference to FIG. 6, the present disclosure is directed to a method for real-time modification of an application of one or more coatings onto a surface of a substrate 22 comprising providing an initial optical vision system 52 for observing the substrate 22 located at an entrance of the system 100. The initial optical vision system 52 is associated with a control unit 26 and a data cloud for identifying one or more of a substrate model, shape, size, position, pattern, application variables, number/type of the coating required, dwell times, activation times, and release times of the coating. The method further comprises placing the substrate 22 on the conveyor structure 28 and transporting the substrate 22 past the initial optical vision system 52 for observation of the substrate 22, transporting the substrate 22 past one or more processing stations 54, and applying one or more coatings to the surface of the substrate 22. Each of the one or more processing stations 54 comprises pumping and dispensing systems 20, 21 for supplying one or more coatings, and a robotic unit 24 associated with the pumping and dispensing systems 20, 21. The robotic unit 24 includes at least a first applicator 10a having at least a first nozzle 12 for dispensing at least one of the one or more coatings onto a substrate 22 surface based on data obtained from at least the initial optical vision system 52. The robotic unit 24 is movable with respect to the substrate 22 surface. The processing stations 54 can also include a processor optical vision system 60 including at least one laser system 16, 18 for observing the application of the coating onto the substrate 22 surface. The method further comprises providing a program logic controller 27 configured for cooperating with the control unit 26, the data cloud, the initial optical vision system 52, and the one or more processing stations 54 for controlling, in real-time, the application of the coating onto the surface of the substrate 22.

The method can include providing a plurality of processing stations 54 for applying a series of coatings to one or more substrates 22 moving along the conveyor structure 28. The method can also include providing one or more clamping systems or positioning mechanisms 56 on the conveyor 28 adjacent to each of the processing stations 54, the one or more positioning mechanisms 56 configured for holding the substrate 22 in place during the application of the coating. The robotic unit 24 includes the first applicator 10a having the first nozzle 12 and can include a second applicator 10b having a second nozzle 14. The first applicator 10a and the second applicator 10b apply at least the first coating and at least a second coating supplied by the pumping and dispensing systems 20, 21. The processor optical vision system 60 can comprise at least a first laser system 16 and at least a second laser system 18 for observing a shape of the substrate 22 and for monitoring the application of at least the first coating and the second coating onto the surface of the substrate 22. The processor optical vision system 60 communicates the monitored information to the control unit 26.

The pumping and dispensing systems 20, 21 can supply two different coating materials to the first applicator 10a and the second applicator 10b, such that two different coatings are applied onto the surface of the substrate 22. The first laser system 16 and the second laser system 18 can observe an amount and/or thickness of coating applied to the surface of the substrate 22 and the control unit 26 is configured for real-time modification of the amount of coating applied to the surface of the substrate 22.

The method can further comprise providing a plurality of laser sensors 36, 38 for monitoring and controlling a consumption of the coatings used by the one or more processing stations 54 and sending consumption data to the control unit 26. This data can be used to perform a cost analysis of the coatings applied and to optimize the performance of the system 100. The method can also comprise providing a series of security scanners 50 adjacent to the conveyor 28 for detecting any abnormalities with the substrate 22 or for detecting the presence of a foreign object within a predetermined safe zone. The one or more of the scanners 50 can send a signal to the control unit 26 and programmable logic controller 27 to stop the movement of the conveyor 28 and/or the robotic unit 24. It can be appreciated that the method of coating can be used to apply one or more coatings to any substrate 22. With reference to FIGS. 7A-7D, the substrate 22a-22d can comprise a flat or curved glass substrate and the one or more processing stations 54 can be configured to apply various coatings, such as a primer, chemical solvents, adhesive, and the like.

The method and system of the present disclosure are capable of monitoring and controlling the consumption of chemical solvents used at each of the processing stations 54, as well as totalizing consumption data, sending the consumption data to the central processing unit 26 and the data cloud, to totalize raw material consumption and the costs incurred in the processes. This same data can be used for statistical multi-varied studies that improve the performance of the system algorithm and improves the method for applying chemical solvents to the substrates 22.

The system of the present disclosure allows for continuous and constant production flexibility, and the continuous processing of different models and requirements without the need to continuously change recipes in the system.

The system also allows for the rational use of chemical solvents, applying the necessary amount and trace, improving the consumption of raw materials of solvent chemicals and applicators used in the process.

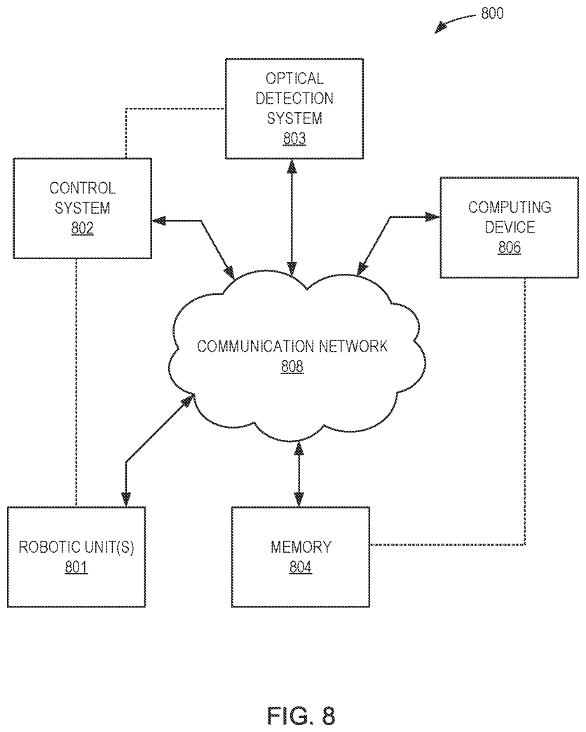

Referring now to FIG. 8, FIG. 8 is a diagram of an example environment 800 in which devices, systems, and/or methods, described herein, may be implemented. As shown in FIG. 8, environment 800 may include one or more robotic units 801, control system 802, optical detection system 803, memory 804, computing device 806, and communication network 808. Robotic unit(s) 801, control system 802, optical detection system 803, memory 804, and computing device 806 may interconnect (e.g., establish a connection to communicate) via wired connections, wireless connections, or a combination of wired and wireless connections.

Robotic unit(s) 801 may include one or more computing devices configured to communicate with control system 802, optical detection system 803, memory 804, and/or computing device 806 at least partly over communication network 808. Robotic unit(s) 801 may include one or more robotic units. Robotic unit(s) 801 may communicate with and/or be included in computing device 806. Robotic unit(s) 801 may include first robotic unit 24a (see FIGS. 4, 5A, 5B, and 6), second robotic unit 24b (see FIGS. 5A and 6), or additional robotic units 24n. Each robotic unit 24a, 24b may be associated with a processing station (STn).

Control system 802 may include one or more computing devices configured to communicate with robotic unit(s) 801, optical detection system 803, memory 804, and/or computing device 806 at least partly over communication network 808. Control system 802 may be configured to receive optical data from optical detection system 803, determine at least one optical indicium of a substrate based on said optical data, transmit the optical indicium to computing device 806, receive at least one pattern from computing device 806, and control robotic unit(s) 801 to apply at least one material to the substrate. Control system 802 may include or be in communication with optical detection system 803 and robotic unit(s) 801.

Optical detection system 803 may include one or more computing devices configured to communicate with robotic unit(s) 801, control system 802, memory 804, and/or computing device 806 at least partly over communication network 808. Optical detection system 803 may be configured to generate optical data (e.g., image data, video data, radiation data, wavelength data, light-based data, visual spectrum-based data, etc.) based on an application process for applying materials to a substrate. Optical detection system 803 may comprise one or more optical vision system 52. Optical detection system 803 may communicate with and/or be included in control system 802. Optical detection system 803 may include first laser system 16 and/or second laser system 18. Optical detection system 803 may include a first optical detection system and a second optical detection system. Second optical detection system may include first laser system 16 and/or second laser system 18. First optical detection system may have an optical view (e.g., an operative optical data detection range) of a conveyor (CBSRVO) 28 that conveys the substrate to robotic unit(s) 801. Second optical detection system may have an optical view of robotic unit(s) 801, including while material is being applied to the substrate.

Memory 804 may include one or more computing devices configured to communicate with robotic unit(s) 801, control system 802, optical detection system 803, and/or computing device 806 at least partly over communication network 808. Memory 804 may be configured to store data associated with patterns for application of materials to substrates in one or more non-transitory computer readable storage media. Memory 804 may communicate with and/or be included in computing device 806.

Computing device 806 may include one or more processors that are configured to communicate with robotic unit(s) 801, control system 802, optical detection system 803, and/or memory 804 at least partly over communication network 808. Computing device 806 may be an edge computing device. Computing device 806 may also be associated with a user and may include at least one user interface for transmitting data to and receiving data from control system 802 and/or memory 804. Computing device 806 may be positioned remotely from control system 802, such as at a remote cloud system. Computing device 806 may include or be in communication with memory 804.

Communication network 808 may include one or more wired and/or wireless networks over which the systems and devices of environment 800 may communicate. For example, communication network 808 may include a cellular network (e.g., a long-term evolution (LTE®) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of these or other types of networks.

The number and arrangement of devices and networks shown in FIG. 8 are provided as an example. There may be additional devices and/or networks, fewer devices and/or networks, different devices and/or networks, or differently arranged devices and/or networks than those shown in FIG. 8. Furthermore, two or more devices shown in FIG. 8 may be implemented within a single device, or a single device shown in FIG. 8 may be implemented as multiple, distributed devices. Additionally or alternatively, a set of devices (e.g., one or more devices) of environment 800 may perform one or more functions described as being performed by another set of devices of environment 800.

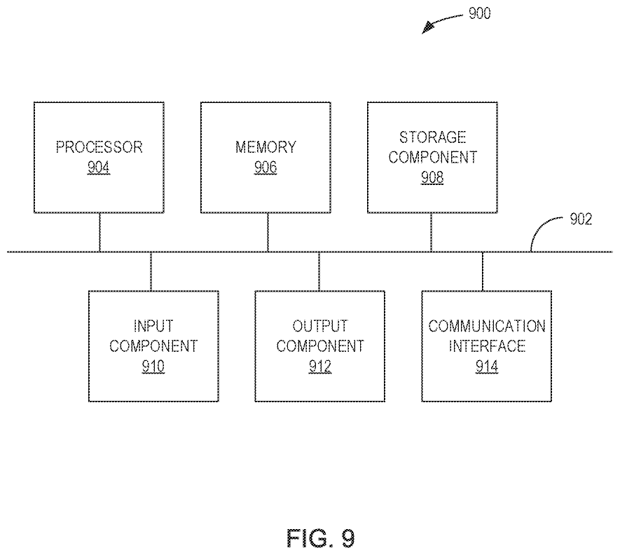

Referring now to FIG. 9, FIG. 9 is a diagram of example components of a device 900, according to some non-limiting embodiments or aspects. Device 900 may correspond to one or more devices of robotic unit(s) 801, control system 802, optical detection system 803, memory 804, computing device 806, and/or communication network 808, as shown in FIG. 8. In some non-limiting embodiments or aspects, such systems or devices may include at least one device 900 and/or at least one component of device 900.

As shown in FIG. 9, device 900 may include bus 902, processor 904, memory 906, storage component 908, input component 910, output component 912, and communication interface 914. Bus 902 may include a component that permits communication among the components of device 900. In some non-limiting embodiments or aspects, processor 904 may be implemented in hardware, firmware, or a combination of hardware and software. For example, processor 904 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 906 may include random access memory (RAM), read only memory (ROM), and/or another type of dynamic or static storage device (e.g., flash memory, magnetic memory, optical memory, etc.) that stores information and/or instructions for use by processor 904.

Storage component 908 may store information and/or software related to the operation and use of device 900. For example, storage component 908 may include a hard disk (e.g., a magnetic disk, an optical disk, a magneto-optic disk, a solid state disk, etc.) and/or another type of computer-readable medium.

Input component 910 may include a component that permits device 900 to receive information, such as via user input (e.g., a touch screen display, a keyboard, a keypad, a mouse, a button, a switch, a microphone, etc.). Additionally, or alternatively, input component 910 may include a sensor for sensing information (e.g., a global positioning system (GPS) component, an accelerometer, a gyroscope, an actuator, etc.). Output component 912 may include a component that provides output information from device 900 (e.g., a display, a speaker, one or more light-emitting diodes (LEDs), etc.).

Communication interface 914 may include a transceiver-like component (e.g., a transceiver, a separate receiver and transmitter, etc.) that enables device 900 to communicate with other devices, such as via a wired connection, a wireless connection, or a combination of wired and wireless connections. Communication interface 914 may permit device 900 to receive information from another device and/or provide information to another device. For example, communication interface 914 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 900 may perform one or more processes described herein. Device 900 may perform these processes based on processor 904 executing software instructions stored by a computer-readable medium, such as memory 906 and/or storage component 908. A computer-readable medium (e.g., a non-transitory computer-readable medium) is defined herein as a non-transitory memory device. A memory device includes memory space located inside of a single physical storage device or memory space spread across multiple physical storage devices.

Software instructions may be read into memory 906 and/or storage component 908 from another computer-readable medium or from another device via communication interface 914. When executed, software instructions stored in memory 906 and/or storage component 908 may cause processor 904 to perform one or more processes described herein. Additionally, or alternatively, hardwired circuitry may be used in place of or in combination with software instructions to perform one or more processes described herein. Thus, embodiments or aspects described herein are not limited to any specific combination of hardware circuitry and software.

The number and arrangement of components shown in FIG. 9 are provided as an example. In some non-limiting embodiments, device 900 may include additional components, fewer components, different components, or differently arranged components than those shown in FIG. 9. Additionally or alternatively, a set of components (e.g., one or more components) of device 900 may perform one or more functions described as being performed by another set of components of device 900.

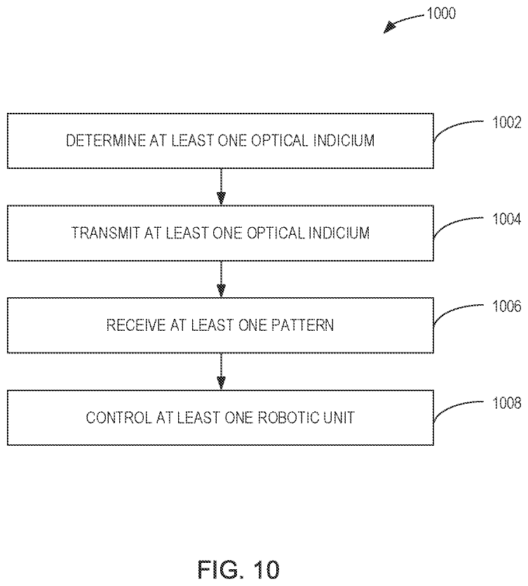

Referring now to FIG. 10, FIG. 10 is a flowchart of a non-limiting embodiment or aspect of a process 1000 for applying materials to a substrate, according to some non-limiting embodiments or aspects. The steps shown in FIG. 10 are for example purposes only. It will be appreciated that additional, fewer, different, and/or a different order of steps may be used in non-limiting embodiments or aspects. In some non-limiting embodiments or aspects, one or more of the steps of process 1000 may be performed (e.g., completely, partially, and/or the like) by control system 802. In some non-limiting embodiments or aspects, one or more of the steps of process 1000 may be performed (e.g., completely, partially, and/or the like) by another system, another device, another group of systems, or another group of devices, separate from or including control system 802.

As shown in FIG. 10, at step 1002, process 1000 may include determining at least one optical indicium. For example, control system 802 may determine at least one optical indicium of a substrate based on data received from at least one optical detection system (e.g., a first optical detection system having an optical view of a conveyor 28 that conveys the substrate to robotic unit(s) 801). Optical indicia may include, but are not limited to, one-dimensional barcodes (e.g., vertical line barcodes), two-dimensional barcodes (e.g., matrix barcodes, quick read (QR) barcodes, etc.), printed symbols (e.g., text, numbers, and/or non-alphanumeric symbols), one or more dimensions of the substrate (e.g., a width, length, thickness, shape, etc.), a color tag, and/or the like. The control system 802 may determine the shape of the substrate in at least two dimensions based on data received from the optical detection system 803 (e.g., one or more laser systems).

As shown in FIG. 10, at step 1004, process 1000 may include transmitting the at least one optical indicium. For example, control system 802 may transmit the at least one optical indicium computing device 806. In some non-limiting embodiments or aspects, computing device 806 may be at least one edge computing device 806. The substrate may be one of a plurality of different types of substrates (e.g., automotive windows, windows, transparent films, etc.) that may be applied with a material. Furthermore, control system 802, while transmitting the at least one optical indicium to the at least one edge computing device 806, may cause (e.g., trigger a responsive reaction by sending a request message to) the at least one edge computing device 806 to determine a type of the substrate based on the at least one optical indicium transmitted to the at least one edge computing device 806, and cause (e.g., trigger a responsive reaction by sending a request message to) the at least one edge computing device 806 to transmit at least one pattern (e.g., one or more trajectories, paths, areas of application, etc.) based on the type of substrate.

As shown in FIG. 10, at step 1006, process 1000 may include receiving at least one pattern. For example, control system 802 may receive at least one pattern (e.g., one or more trajectories for applying a substrate, a shape of a path for application, an area for application, etc.) from computing device 806. In some non-limiting embodiments or aspects, computing device 806 may receive the at least one optical indicium, determine the at least one pattern based on the at least one optical indicium (e.g., by determining a type of the substrate based on the at least one optical indicium and looking up at least one pattern saved in memory 804 associated with the type of the substrate), and transmit the at least one pattern to control system 802.

As shown in FIG. 10, at step 1008, process 1000 may include controlling at least one robotic unit 801. For example, control system 802 may control robotic unit(s) 801 having at least one robot including at least one nozzle to apply at least one material (e.g., primer) to the substrate (e.g., an automotive window). Controlling the at least one robotic unit 801 may include causing robotic unit(s) 801 to apply the at least one material to the substrate based on the at least one pattern. In some non-limiting embodiments or aspects, control system 802 may cause robotic unit(s) 801 to apply the at least one material to the substrate based on the at least one pattern by determining at least one application parameter using the at least one optical detection system (e.g., a second optical detection system having a view of robotic unit(s) 801) while the at least one material is being applied to the substrate. The at least one application parameter may include one or more parameters including, but not limited to, an amount of the at least one material that has been applied to the substrate, a thickness of the at least one material that has been applied to the substrate, a width of the at least one material that has been applied to the substrate, a position of the at least one material that has been applied to the substrate, or any combination thereof. In some non-limiting embodiments or aspects, control system 802 may cause robotic unit(s) 801 to apply the at least one material to the substrate based on the at least one pattern by continually modifying movement of the robotic unit(s) 801 based on the at least one application parameter and that at least one pattern as the at least one material is being applied.

In some non-limiting embodiments or aspects, the robotic unit(s) 801 may include a first robotic unit and a second robotic unit. The first robotic unit may include a first robot including a first nozzle for applying a first material of the at least one material to the substrate. The second robotic unit may include a second robot including a second nozzle for applying a second material of the at least one material to the substrate. The first material and second material may differ. In some non-limiting embodiments or aspects, control system 802 may control the first and second robotic units to apply the at least one material to the substrate by causing the first robotic unit to apply the first material to the substrate based on a first pattern of the at least one pattern, and by causing the second robotic unit to apply the second material to the substrate based on a second pattern of the at least one pattern. The first pattern and the second pattern may differ.

In some non-limiting embodiments or aspects, control system 802 may continually modify movement of robotic unit(s) 801 based on the at least one pattern and based on ongoing data received from optical detection system 803 (e.g., one or more laser systems). For example, one or more laser systems may function as locator sensors and the ongoing data may include position data (e.g., distance, relative location, absolute location, etc.) of at least one material that has been applied to the substrate. Control system 802 may continually modify movement of robotic unit(s) 801 based on the at least one pattern and ongoing data by generating an application trajectory (e.g., actual path taken by nozzle while applying material) based on the ongoing data, comparing the application trajectory to a predetermined trajectory (e.g., preset path taken by nozzle for applying material) of the at least one pattern, and modifying the movement (e.g., x-axis movement, y-axis movement, z-axis movement, rotational axis movement, or any other rotation or translocation) of robotic unit(s) 801 to adjust the application trajectory to be closer to (e.g., having a path that more closely matches) the predetermined trajectory.

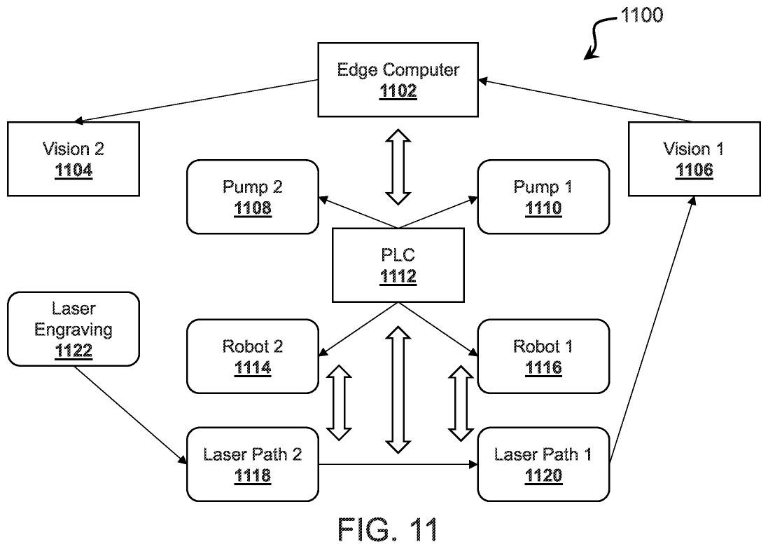

Referring now to FIG. 11, FIG. 11 shows a system 1100, according to non-limiting embodiments or aspects of the present disclosure.

In some non-limiting embodiments or aspects, system 1100 may include edge computer 1102. Edge computer 1102 may include one or more computing devices configured to control one or more devices of system 1100. Edge computer 1102 may include or be associated with at least one database to store data for controlling one or more devices of system 1100. For example, at least one database may include data for geometric dimensioning and tolerancing (GD&T), which may include data configured to define and communicate design intent and engineering tolerance, to optimally control variations in the manufacturing process. By way of further example, at least one database may include data for operating one or more devices of system 1100. By way of further example, at least one database may include data for carrying out statistical regression analysis of the performance of system 1100. Edge computer 1102 may load a receipt from the at least one database that defines a routine or process for system 1100. Edge computer 1102 may communicate the receipt to programmable logic controller (PLC) 1112. Edge computer 1102 may send data to and receive data from PLC 1112, associated with the functioning of system 1100.

In some non-limiting embodiments or aspects, system 1100 may include a first vision process (Vision 1) 1106 and a second vision process (Vision 2) 1104. A vision process may be carried out using one or more image sensors (e.g., a camera, a photosensor, etc.) in tandem with one or more processors. First vision process 1106 may capture image data of at least one optical indicium, e.g., a shape of the substrate, a bar code associated with the substrate, a two-dimensional barcode associated with the substrate (e.g., a QR code), text associated with the substrate, and/or the like. Second vision process 1104 may be configured to cause first vision process 1106 to loop, as well as to update the image stored in memory (e.g., short-term memory, long-term memory, etc.).

In some non-limiting embodiments or aspects, system 1100 may include a first pump (Pump 1) 1110 and a second pump (Pump 2) 1108. Each pump 1110, 1108 may be configured to supply at least one material from a reservoir of the material to the substrate. For example, first pump 1110 may cause a first material to be transferred from a first reservoir associated with first robot 1116, through a nozzle associated with first robot 1116, and onto substrate. By way of further example, second pump 1108 may cause a second material to be transferred from a second reservoir associated with second robot 1114, through a nozzle associated with second robot 1114, and onto substrate.

In some non-limiting embodiments or aspects, system 1100 may include at least one programming logic controller (PLC) 1112. PLC 1112 may be configured to receive a receipt from edge computer 1102 including data defining the scope of control of system 1100. PLC 1112 may further be configured to send and receive values associated with operational parameters of system 1100, to and from edge computer 1102. Furthermore, PLC 1112 may be configured to communicate with first pump 1110 and second pump 1108 to determine the amount and rate of consumption of material, the pressure of the material being urged by a pump, the temperature of the material forced through a nozzle, and/or the like. PLC 1112 may be configured to communicate with one or more weight sensors, pressure sensors, temperature sensors, fluid sensors, and/or the like, to obtain operational information. PLC 1112 may be further configured to cause each robot 1116, 1114 to load an operational routine, based on data received from edge computer 1102, and likewise control the operation of first robot 1116 and second robot 1114.

In some non-limiting embodiments or aspects, system 1100 may include first robot 1116 and second robot 1114. First robot 1116 may include and/or be associated with first pump 1110 and first laser path (Laser Path 1) 1120. Second robot 1114 may include and/or be associated with second pump 1108 and second laser path (Laser Path 2) 1118. First robot 1116 may include a nozzle for applying a first material to the substrate, and first robot 1116 may manipulate the position of its nozzle in space. Second robot 1114 may include a nozzle for applying a second material to the substrate, and second robot 1114 may manipulate the position of its nozzle in space. First robot 1116 may follow first laser path 1120 to guide the application of the first material. Second robot 1114 may follow second laser path 1118 to guide the application of the second material. A laser path may include a predefined application pattern of one or more materials, and a substrate may be provided to system 1100 having undergone a laser engraving process 1122. Second vision process 1104 may determine information about the substrate based on laser engraving process 1122. Laser engraving process 1122 may inscribe information onto the substrate related to the substrate's manufacturing line, manufacturing date, and/or the like, including process control data. Laser engraving process 1122 may further define first laser path 1120 and second laser path 1118. If laser engraving process 1122 places substrate information on the substrate, that information may be detected by first vision process 1106.

Additional embodiments or aspects of the robotic applicator and coating system and method are detailed in one or more of the following clauses.

Clause 1: A computer-implemented method comprising: determining, with at least one processor, at least one optical indicium of a substrate based on data received from at least one optical detection system; transmitting, with at least one processor, the at least one optical indicium to at least one edge computing device; receiving, with at least one processor, at least one pattern from the at least one edge computing device; and controlling, with at least one processor, at least one robotic unit having at least one robot comprising at least one nozzle to apply at least one material to the substrate, wherein controlling the at least one robotic unit comprises: causing the at least one robotic unit to apply the at least one material to the substrate based on the at least one pattern.

Clause 2: The computer-implemented method of clause 1, wherein causing the at least one robotic unit to apply the at least one material to the substrate based on the at least one pattern comprises: determining at least one application parameter using the at least one optical detection system while the at least one material is being applied to the substrate, wherein the at least one application parameter comprises at least one of: an amount of the at least one material that has been applied to the substrate; a thickness of the at least one material that has been applied to the substrate; a width of the at least one material that has been applied to the substrate; a position of the at least one material that has been applied to the substrate; or any combination thereof; and continually modifying movement of the at least one robotic unit based on the at least one application parameter and the at least one pattern.

Clause 3: The computer-implemented method of clause 1 or clause 2, wherein the at least one optical detection system comprises a first optical detection system and a second optical detection system, wherein the first optical detection system has an optical view of a conveyor that conveys the substrate to the at least one robotic unit, wherein the second optical detection system has an optical view of the at least one robotic unit while the at least one material is being applied to the substrate, wherein determining the at least one optical indicium of the substrate based on the data received from the at least one optical detection system comprises determining the at least one optical indicium of the substrate based on the data received from the first optical detection system, and wherein determining the at least one application parameter using the at least one optical detection system comprises determining the at least one application parameter using the second optical detection system.

Clause 4: The computer-implemented method of any of clauses 1-3, wherein the at least one robotic unit comprises a first robotic unit and a second robotic unit, wherein the first robotic unit comprises a first robot comprising a first nozzle for applying a first material of the at least one material to the substrate, wherein the second robotic unit comprises a second robot comprising a second nozzle for applying a second material of the at least one material to the substrate, wherein the second material is a different material from the first material, and wherein controlling the at least one robotic unit to apply the at least one material to the substrate comprises: causing the first robotic unit to apply the first material to the substrate based on a first pattern of the at least one pattern; and causing the second robotic unit to apply the second material to the substrate based on a second pattern of the at least one pattern.

Clause 5: The computer-implemented method of any of clauses 1-4, wherein the substrate is one of a plurality of different types of substrates, and wherein transmitting the at least one optical indicium to the at least one edge computing device comprises: causing the at least one edge computing device to determine a type of the substrate based on the at least one optical indicium transmitted to the at least one edge computing device; and causing the at least one edge computing device to transmit the at least one pattern based on the type of the substrate.

Clause 6: The computer-implemented method of any of clauses 1-5, wherein the at least one optical indicium comprises at least one of: a one-dimensional barcode, a two-dimensional barcode, printed symbols, a shape of the substrate, or any combination thereof.

Clause 7: The computer-implemented method of any of clauses 1-6, wherein the at least one optical detection system comprises at least one laser system mounted on the at least one robotic unit, and wherein the at least one optical indicium comprises the shape of the substrate, the method further comprising: determining, with at least one processor, the shape of the substrate in at least two dimensions based on data received from the at least one laser system.

Clause 8: The computer-implemented method of any of clauses 1-7, wherein causing the at least one robotic unit to apply the at least one material to the substrate based on the at least one pattern comprises: continually modifying movement of the at least one robotic unit based on the at least one pattern and based on ongoing data received from the at least one laser system.

Clause 9: The computer-implemented method of any of clauses 1-8, wherein the at least one laser system functions as a locator sensor and the ongoing data comprises position data of the at least one material that has been applied to the substrate, and wherein continually modifying the movement of the at least one robotic unit based on the at least one pattern and based on the ongoing data comprises: generating an application trajectory based on the ongoing data; comparing the application trajectory to a predetermined trajectory of the at least one pattern; and modifying the movement of the at least one robotic unit to adjust the application trajectory to be closer to the predetermined trajectory.

Clause 10: The computer-implemented method of any of clauses 1-9, wherein the substrate is an automotive glass substrate and the at least one material comprises a primer.

Clause 11: A system comprising: at least one processor; at least one optical detection system; and at least one robotic unit having at least one robot comprising at least one nozzle configured to apply at least one material to a substrate; wherein the at least one processor is programmed or configured to: determine at least one optical indicium of the substrate based on data received from the at least one optical detection system; transmit the at least one optical indicium to at least one edge computing device; receive at least one pattern from the at least one edge computing device; and control the at least one robotic unit to apply the at least one material to the substrate, wherein controlling the at least one robotic unit comprises: causing the at least one robotic unit to apply the at least one material to the substrate based on the at least one pattern.

Clause 12: The system of clause 11, wherein, when causing the at least one robotic unit to apply the at least one material to the substrate based on the at least one pattern, the at least one processor is programmed or configured to: determine at least one application parameter using the at least one optical detection system while the at least one material is being applied to the substrate, wherein the at least one application parameter comprises at least one of: an amount of the at least one material that has been applied to the substrate; a thickness of the at least one material that has been applied to the substrate; a width of the at least one material that has been applied to the substrate; a position of the at least one material that has been applied to the substrate; or any combination thereof; and continually modify movement of the at least one robotic unit based on the at least one application parameter and the at least one pattern.

Clause 13: The system of clause 11 or clause 12, wherein the at least one optical detection system comprises a first optical detection system and a second optical detection system, wherein the first optical detection system has an optical view of a conveyor that conveys the substrate to the at least one robotic unit, wherein the second optical detection system has an optical view of the at least one robotic unit while the at least one material is being applied to the substrate, wherein while determining the at least one optical indicium of the substrate based on the data received from the at least one optical detection system, the at least one processor is programmed or configured to determine the at least one optical indicium of the substrate based on the data received from the first optical detection system, and wherein while determining the at least one application parameter using the at least one optical detection system, the at least one processor is programmed or configured to determine the at least one application parameter using the second optical detection system.

Clause 14: The system of any of clauses 11-13, wherein the at least one robotic unit comprises a first robotic unit and a second robotic unit, wherein the first robotic unit comprises a first robot comprising a first nozzle for applying a first material of the at least one material to the substrate, wherein the second robotic unit comprises a second robot comprising a second nozzle for applying a second material of the at least one material to the substrate, wherein the second material is a different material from the first material, and wherein, when controlling the at least one robotic unit to apply the at least one material to the substrate, the at least one processor is programmed or configured to: cause the first robotic unit to apply the first material to the substrate based on a first pattern of the at least one pattern; and cause the second robotic unit to apply the second material to the substrate based on a second pattern of the at least one pattern.

Clause 15: The system of any of clauses 11-14, wherein the substrate is one of a plurality of different types of substrates, and wherein, when transmitting the at least one optical indicium to the at least one edge computing device, the at least one processor is programmed or configured to: cause the at least one edge computing device to determine a type of the substrate based on the at least one optical indicium transmitted to the at least one edge computing device; and cause the at least one edge computing device to transmit the at least one pattern based on the type of the substrate.

Clause 16: The system of any of clauses 11-15, wherein the at least one optical indicium comprises at least one of: a one-dimensional barcode, a two-dimensional barcode, printed symbols, a shape of the substrate, or any combination thereof.

Clause 17: The system of any of clauses 11-16, wherein the at least one optical detection system comprises at least one laser system mounted on the at least one robotic unit, wherein the at least one optical indicium comprises the shape of the substrate, and wherein the at least one processor is further programmed or configured to: determine the shape of the substrate in at least two dimensions based on data received from the at least one laser system.

Clause 18: The system of any of clauses 11-17, wherein, when causing the at least one robotic unit to apply the at least one material to the substrate based on the at least one pattern, the at least one processor is programmed or configured to: continually modify movement of the at least one robotic unit based on the at least one pattern and based on ongoing data received from the at least one laser system.

Clause 19: The system of any of clauses 11-18, wherein the at least one laser system functions as a locator sensor and the ongoing data comprises position data of the at least one material that has been applied to the substrate, and wherein, when continually modifying the movement of the at least one robotic unit based on the at least one pattern and based on the ongoing data, the at least one processor is programmed or configured to: generate an application trajectory based on the ongoing data; compare the application trajectory to a predetermined trajectory of the at least one pattern; and modify the movement of the at least one robotic unit to adjust the application trajectory to be closer to the predetermined trajectory.

Clause 20: The system of any of clauses 11-19, wherein the substrate is an automotive glass substrate and the at least one material comprises a primer.

Clause 21: A computer program product comprising at least one non-transitory computer-readable medium comprising one or more instructions that, when executed by at least one processor, cause the at least one processor to: determine at least one optical indicium of a substrate based on data received from at least one optical detection system; transmit the at least one optical indicium to at least one edge computing device; receive at least one pattern from the at least one edge computing device; and control at least one robotic unit having at least one robot comprising at least one nozzle to apply at least one material to the substrate, wherein the one or more instructions that cause the at least one processor to control the at least one robotic unit, cause the at least one processor to: cause the at least one robotic unit to apply the at least one material to the substrate based on the at least one pattern.

Clause 22: The computer program product of clause 21, wherein the one or more instructions that cause the at least one processor to cause the at least one robotic unit to apply the at least one material to the substrate based on the at least one pattern, cause the at least one processor to: determine at least one application parameter using the at least one optical detection system while the at least one material is being applied to the substrate, wherein the at least one application parameter comprises at least one of: an amount of the at least one material that has been applied to the substrate; a thickness of the at least one material that has been applied to the substrate; a width of the at least one material that has been applied to the substrate; a position of the at least one material that has been applied to the substrate; or any combination thereof; and continually modify movement of the at least one robotic unit based on the at least one application parameter and the at least one pattern.

Clause 23: The computer program product of clause 21 or clause 22, wherein the at least one optical detection system comprises a first optical detection system and a second optical detection system, wherein the first optical detection system has an optical view of a conveyor that conveys the substrate to the at least one robotic unit, wherein the second optical detection system has an optical view of the at least one robotic unit while the at least one material is being applied to the substrate, wherein the one or more instructions that cause the at least one processor to determine the at least one optical indicium of the substrate based on the data received from the at least one optical detection system cause the at least one processor to determine the at least one optical indicium of the substrate based on the data received from the first optical detection system, and wherein the one or more instructions that cause the at least one processor to determine the at least one application parameter using the at least one optical detection system cause the at least one processor to determine the at least one application parameter using the second optical detection system.

Clause 24: The computer program product of any of clauses 21-23, wherein the at least one robotic unit comprises a first robotic unit and a second robotic unit, wherein the first robotic unit comprises a first robot comprising a first nozzle for applying a first material of the at least one material to the substrate, wherein the second robotic unit comprises a second robot comprising a second nozzle for applying a second material of the at least one material to the substrate, wherein the second material is a different material from the first material, and wherein the one or more instructions that cause the at least one processor to control the at least one robotic unit to apply the at least one material to the substrate, cause the at least one processor to: cause the first robotic unit to apply the first material to the substrate based on a first pattern of the at least one pattern; and cause the second robotic unit to apply the second material to the substrate based on a second pattern of the at least one pattern.

Clause 25: The computer program product of any of clauses 21-24, wherein the substrate is one of a plurality of different types of substrates, and wherein the one or more instructions that cause the at least one processor to transmit the at least one optical indicium to the at least one edge computing device, cause the at least one processor to: cause the at least one edge computing device to determine a type of the substrate based on the at least one optical indicium transmitted to the at least one edge computing device; and cause the at least one edge computing device to transmit the at least one pattern based on the type of the substrate.

Clause 26: The computer program product of any of clauses 21-25 wherein the at least one optical indicium comprises at least one of: a one-dimensional barcode, a two-dimensional barcode, printed symbols, a shape of the substrate, or any combination thereof.

Clause 27: The computer program product of any of clauses 21-26, wherein the at least one optical detection system comprises at least one laser system mounted on the at least one robotic unit, and wherein the at least one optical indicium comprises the shape of the substrate, the one or more instructions further causing the at least one processor to: determine the shape of the substrate in at least two dimensions based on data received from the at least one laser system.

Clause 28: The computer program product of any of clauses 21-27, wherein the one or more instructions that cause the at least one processor to cause the at least one robotic unit to apply the at least one material to the substrate based on the at least one pattern, cause the at least one processor to: continually modify movement of the at least one robotic unit based on the at least one pattern and based on ongoing data received from the at least one laser system.

Clause 29: The computer program product of any of clauses 21-28, wherein the at least one laser system functions as a locator sensor and the ongoing data comprises position data of the at least one material that has been applied to the substrate, and wherein the one or more instructions that cause the at least one processor to continually modify the movement of the at least one robotic unit based on the at least one pattern and based on the ongoing data, cause the at least one processor to: generate an application trajectory based on the ongoing data; compare the application trajectory to a predetermined trajectory of the at least one pattern; and modify the movement of the at least one robotic unit to adjust the application trajectory to be closer to the predetermined trajectory.

Clause 30: The computer program product of any of clauses 21-29, wherein the substrate is an automotive glass substrate and the at least one material comprises a primer.

While the disclosure has been described as having exemplary designs, the present disclosure can be further modified within the spirit and scope of this disclosure. This application is, therefore, intended to cover any variations, uses, or adaptations of the disclosure using its general principles. Further, this application is intended to cover such departures from the present disclosure as come within the known or customary practice in the art to which this disclosure pertains and which falls within the limits of the appended claims.

What is claimed is:

1. A computer-implemented method comprising:
determining, with at least one processor, at least one optical indicium of a substrate based on data received from at least one optical detection system;
transmitting, with at least one processor, the at least one optical indicium to at least one edge computing device;
receiving, with at least one processor, at least one pattern from the at least one edge computing device; and
controlling, with at least one processor, at least one robotic unit having at least one robot comprising at least one nozzle to apply at least one material to the substrate, wherein controlling the at least one robotic unit comprises:
causing the at least one robotic unit to apply the at least one material to the substrate based on the at least one pattern.

2. The computer-implemented method of claim 1, wherein causing the at least one robotic unit to apply the at least one material to the substrate based on the at least one pattern comprises:
determining at least one application parameter using the at least one optical detection system while the at least one material is being applied to the substrate, wherein the at least one application parameter comprises at least one of: an amount of the at least one material that has been applied to the substrate; a thickness of the at least one material that has been applied to the substrate; a width of the at least one material that has been applied to the substrate; a position of the at least one material that has been applied to the substrate; or any combination thereof; and
continually modifying movement of the at least one robotic unit based on the at least one application parameter and the at least one pattern.

3. The computer-implemented method of claim 2, wherein the at least one optical detection system comprises a first optical detection system and a second optical detection system, wherein the first optical detection system has an optical view of a conveyor that conveys the substrate to the at least one robotic unit, wherein the second optical detection system has an optical view of the at least one robotic unit while the at least one material is being applied to the substrate, wherein determining the at least one optical indicium of the substrate based on the data received from the at least one optical detection system comprises determining the at least one optical indicium of the substrate based on the data received from the first optical detection system, and wherein determining the at least one application parameter using the at least one optical detection system comprises determining the at least one application parameter using the second optical detection system.

4. The computer-implemented method of claim 1, wherein the at least one robotic unit comprises a first robotic unit and a second robotic unit, wherein the first robotic unit comprises a first robot comprising a first nozzle for applying a first material of the at least one material to the substrate, wherein the second robotic unit comprises a second robot comprising a second nozzle for applying a second material of the at least one material to the substrate, wherein the second material is a different material from the first material, and wherein controlling the at least one robotic unit to apply the at least one material to the substrate comprises:
causing the first robotic unit to apply the first material to the substrate based on a first pattern of the at least one pattern; and
causing the second robotic unit to apply the second material to the substrate based on a second pattern of the at least one pattern.

5. The computer-implemented method of claim 1, wherein the substrate is one of a plurality of different types of substrates, and wherein transmitting the at least one optical indicium to the at least one edge computing device comprises:
causing the at least one edge computing device to determine a type of the substrate based on the at least one optical indicium transmitted to the at least one edge computing device; and
causing the at least one edge computing device to transmit the at least one pattern based on the type of the substrate.

6. The computer-implemented method of claim 1, wherein the at least one optical indicium comprises at least one of: a one-dimensional barcode, a two-dimensional barcode, printed symbols, a shape of the substrate, or any combination thereof.

7. The computer-implemented method of claim 6, wherein the at least one optical detection system comprises at least one laser system mounted on the at least one robotic unit, and wherein the at least one optical indicium comprises the shape of the substrate, the method further comprising:
determining, with at least one processor, the shape of the substrate in at least two dimensions based on data received from the at least one laser system.

8. The computer-implemented method of claim 7, wherein causing the at least one robotic unit to apply the at least one material to the substrate based on the at least one pattern comprises:
continually modifying movement of the at least one robotic unit based on the at least one pattern and based on ongoing data received from the at least one laser system.

9. The computer-implemented method of claim 8, wherein the at least one laser system functions as a locator sensor and the ongoing data comprises position data of the at least one material that has been applied to the substrate, and wherein continually modifying the movement of the at least one robotic unit based on the at least one pattern and based on the ongoing data comprises:
generating an application trajectory based on the ongoing data;
comparing the application trajectory to a predetermined trajectory of the at least one pattern; and
modifying the movement of the at least one robotic unit to adjust the application trajectory to be closer to the predetermined trajectory.

10. The computer-implemented method of claim 1, wherein the substrate is an automotive glass substrate and the at least one material comprises a primer.

11. A system comprising:
at least one processor;
at least one optical detection system; and
at least one robotic unit having at least one robot comprising at least one nozzle configured to apply at least one material to a substrate;
wherein the at least one processor is programmed or configured to:
determine at least one optical indicium of the substrate based on data received from the at least one optical detection system;
transmit the at least one optical indicium to at least one edge computing device;
receive at least one pattern from the at least one edge computing device; and
control the at least one robotic unit to apply the at least one material to the substrate, wherein controlling the at least one robotic unit comprises:
causing the at least one robotic unit to apply the at least one material to the substrate based on the at least one pattern.

12. The system of claim 11, wherein, when causing the at least one robotic unit to apply the at least one material to the substrate based on the at least one pattern, the at least one processor is programmed or configured to:
determine at least one application parameter using the at least one optical detection system while the at least one material is being applied to the substrate, wherein the at least one application parameter comprises at least one of: an amount of the at least one material that has been applied to the substrate; a thickness of the at least one material that has been applied to the substrate; a width of the at least one material that has been applied to the substrate; a position of the at least one material that has been applied to the substrate; or any combination thereof; and
continually modify movement of the at least one robotic unit based on the at least one application parameter and the at least one pattern.

13. The system of claim 11, wherein the at least one optical detection system comprises a first optical detection system and a second optical detection system, wherein the first optical detection system has an optical view of a conveyor that conveys the substrate to the at least one robotic unit, wherein the second optical detection system has an optical view of the at least one robotic unit while the at least one material is being applied to the substrate, wherein while determining the at least one optical indicium of the substrate based on the data received from the at least one optical detection system, the at least one processor is programmed or configured to determine the at least one optical indicium of the substrate based on the data received from the first optical detection system, and wherein while determining the at least one application parameter using the at least one optical detection system, the at least one processor is programmed or configured to determine the at least one application parameter using the second optical detection system.

14. The system of claim 11, wherein the at least one robotic unit comprises a first robotic unit and a second robotic unit, wherein the first robotic unit comprises a first robot comprising a first nozzle for applying a first material of the at least one material to the substrate, wherein the second robotic unit comprises a second robot comprising a second nozzle for applying a second material of the at least one material to the substrate, wherein the second material is a different material from the first material, and wherein, when controlling the at least one robotic unit to apply the at least one material to the substrate, the at least one processor is programmed or configured to:
cause the first robotic unit to apply the first material to the substrate based on a first pattern of the at least one pattern; and
cause the second robotic unit to apply the second material to the substrate based on a second pattern of the at least one pattern.

15. The system of claim 11, wherein the substrate is one of a plurality of different types of substrates, and wherein, when transmitting the at least one optical indicium to the at least one edge computing device, the at least one processor is programmed or configured to:
cause the at least one edge computing device to determine a type of the substrate based on the at least one optical indicium transmitted to the at least one edge computing device; and
cause the at least one edge computing device to transmit the at least one pattern based on the type of the substrate.

16. A computer program product comprising at least one non-transitory computer-readable medium comprising one or more instructions that, when executed by at least one processor, cause the at least one processor to:
determine at least one optical indicium of a substrate based on data received from at least one optical detection system;
transmit the at least one optical indicium to at least one edge computing device;
receive at least one pattern from the at least one edge computing device; and
control at least one robotic unit having at least one robot comprising at least one nozzle to apply at least one material to the substrate, wherein the one or more instructions that cause the at least one processor to control the at least one robotic unit, cause the at least one processor to:
cause the at least one robotic unit to apply the at least one material to the substrate based on the at least one pattern.

17. The computer program product of claim 16, wherein the one or more instructions that cause the at least one processor to cause the at least one robotic unit to apply the at least one material to the substrate based on the at least one pattern, cause the at least one processor to:
determine at least one application parameter using the at least one optical detection system while the at least one material is being applied to the substrate, wherein the at least one application parameter comprises at least one of: an amount of the at least one material that has been applied to the substrate; a thickness of the at least one material that has been applied to the substrate; a width of the at least one material that has been applied to the substrate; a position of the at least one material that has been applied to the substrate; or any combination thereof; and
continually modify movement of the at least one robotic unit based on the at least one application parameter and the at least one pattern.

18. The computer program product of claim 17, wherein the at least one optical detection system comprises a first optical detection system and a second optical detection system, wherein the first optical detection system has an optical view of a conveyor that conveys the substrate to the at least one robotic unit, wherein the second optical detection system has an optical view of the at least one robotic unit while the at least one material is being applied to the substrate, wherein the one or more instructions that cause the at least one processor to determine the at least one optical indicium of the substrate based on the data received from the at least one optical detection system cause the at least one processor to determine the at least one optical indicium of the substrate based on the data received from the first optical detection system, and wherein the one or more instructions that cause the at least one processor to determine the at least one application parameter using the at least one optical detection system cause the at least one processor to determine the at least one application parameter using the second optical detection system.

19. The computer program product of claim 16, wherein the at least one robotic unit comprises a first robotic unit and a second robotic unit, wherein the first robotic unit comprises a first robot comprising a first nozzle for applying a first material of the at least one material to the substrate, wherein the second robotic unit comprises a second robot comprising a second nozzle for applying a second material of the at least one material to the substrate, wherein the second material is a different material from the first material, and wherein the one or more instructions that cause the at least one processor to control the at least one robotic unit to apply the at least one material to the substrate cause the at least one processor to:
cause the first robotic unit to apply the first material to the substrate based on a first pattern of the at least one pattern; and
cause the second robotic unit to apply the second material to the substrate based on a second pattern of the at least one pattern.

20. The computer program product of claim 16, wherein the substrate is one of a plurality of different types of substrates, and wherein the one or more instructions that cause the at least one processor to transmit the at least one optical indicium to the at least one edge computing device, cause the at least one processor to:
cause the at least one edge computing device to determine a type of the substrate based on the at least one optical indicium transmitted to the at least one edge computing device; and
cause the at least one edge computing device to transmit the at least one pattern based on the type of the substrate.
